(19) United States
(12) Patent Application Publication
(10) Pub. No.: US 2011/0085232 A1
(43) Pub. Date: Apr. 14, 2011

(54) MULTI-SPECTRAL FILTERS, MIRRORS AND ANTI-REFLECTIVE COATINGS WITH SUBWAVELENGTH PERIODIC FEATURES FOR OPTICAL DEVICES

(75) Inventors: Douglas H. Werner, State College, PA (US); Theresa S. Mayer, Port Matilda, PA (US); Clara R. Baleine, Orlando, FL (US)

(73) Assignees: The Penn State Research Foundation, University Park, PA (US); Lockheed Martin Corporation

(21) Appl. No.: 12/900,967

(22) Filed: Oct. 8, 2010

Related U.S. Application Data
(60) Provisional application No. 61/249,825, filed on Oct. 8, 2009.

(51) Int. Cl. G02B 5/18

(52) U.S. Cl. 359/350; 359/569; 359/575; 359/576

(57) ABSTRACT

Example apparatus have a radiation-receiving surface configured to receive electromagnetic radiation, including a sub-wavelength grating supported by a substrate. The sub-wavelength grating has a side-wall profile that may be configured and optimized to obtain desired spectral properties.

### REFERENCE TO RELATED APPLICATION

This U.S. non-provisional utility patent application claims priority from U.S. provisional patent application Ser. No. 61/249,825, filed Oct. 8, 2009, the entire content of which is incorporated herein in its entirety.

### BACKGROUND OF THE INVENTION

Optical devices are used in numerous applications. However, conventional fabrication techniques may encounter difficulties, for example in the processing of hard materials. Also, conventional structures may limit the optical properties available for instance, to overcome trade-offs between peak reflection values and field of view, or polarization independent designs, and require complex structures for certain desired properties.

### SUMMARY OF THE INVENTION

Example apparatus include an optical element having a surface configured to receive incident electromagnetic radiation having an electromagnetic wavelength, comprising protrusions (such as ridges) formed at the surface of the optical element, the ridges being spaced apart so as to define grooves. The protrusions have a periodicity less than the electromagnetic wavelength of incident radiation. The protrusions have a side-wall structure, the optical element having an optical property determined by the side-wall structure. Protrusions, such as ridges, may have a spacing (e.g. from center to center of adjacent ridges) of less than one half the operational electromagnetic wavelength.

An example optical element configured to operate in the IR and/or visible spectral regions has an incident surface receiving incident radiation, and an optical property determined by the shape and spacing of repeated subwavelength structures at the incident structures, the subwavelength structures being optionally formed in a single material. The single material may be provided a single coating layer supported by the substrate, or may be the substrate material. A subwavelength structures has at least one size parameter less than the operational electromagnetic wavelength, such as width, height, spacing (e.g. periodicity), side-wall feature, or other parameter.

The optical element may be, for example, a reflector (such as a mirror), window, filter (such as a notch filter, band pass filter, or combination thereof), refractive element (such as a lens), prism, polarizer, beams-splitter, or absorber.

An optical element may be a multi-band optical element having an optical property optimized at a plurality of wavelengths by configuration of the side-wall structure, and (possibly to a lesser extent) the periodicity or other feature of the protrusions.

Example apparatus include an IR optical element having a high reflectivity or high transmissivity at first and second predetermined wavelengths, the electromagnetic wavelength being in the range 0.5-100 microns, the first and second predetermined wavelengths being separated by a wavelength spacing of at least 0.5 microns. A high reflectivity may be a reflectivity of at least 95%, and a high transmissitivity may be a transmissivity of at least 95%.

Example apparatus include an optical element having an operational electromagnetic wavelength range and comprising a substrate having a substrate surface, and an array of protrusions extending from the substrate along an extension direction. The extension direction may be the surface normal. The protrusions have a top surface and side-walls having a side-wall profile. The side-wall profile undulates relative to the extension direction. An undulation may include an appreciable deviation in a direction parallel to the local substrate surface, for example of at least 50 nm in a nanoscale sub-wavelength grating. The side-wall profile may include at least one oscillatory component having an amplitude of at least 50 nm.

The protrusions may have a spacing less than radiation wavelengths within the designed electromagnetic wavelength range for the apparatus. For example, for a filter or reflector having designed reflection peaks or notches, the protrusion spacing (or pitch) may be less than the wavelength at these peaks or notches.

Protrusions, such as ridges, pillars and the like, may have a base attached to the substrate, first and second opposed side-walls, and a top surface. The first and second side-walls may have side wall profiles that are mirror-images of each other. Side-wall profiles of neighboring protrusions may define a groove between them, the groove having a width (measured between adjacent side-walls) that first widens, then narrow, then widens again when moving away from the substrate. Various configurations are possible, including grooves having a narrowed region in a central portion between the base and opening of the groove.

Example apparatus may have a radiation-receiving surface configured to receive electromagnetic radiation, and a sub-wavelength grating supported by a substrate, the sub-wavelength grating defining grooves along the radiation-receiving surface. The grooves have a base proximate the substrate, and a groove opening at the top (as illustrated in various examples, though terms such as top and base do not imply that a specific orientation of the surface is necessary). The sub-wavelength grating has a side-wall profile such that each groove has at least one narrowed portion located between the groove base and the groove opening. The protrusions may be in a regular array, along one or more dimensions.

Example apparatus include a hard substrate, such as a ceramic substrate, for example comprising silicon carbide, boron carbide, other carbides, nitrides, oxides (such as aluminum oxide), or other hard material. A hard material may have a Mohs hardness of greater than 7, more particularly greater than 8, and in some examples greater than 9. Such hard materials are difficult to process, and particularly difficult to polish to a mirror finish. However, by forming subwavelength structures within a dielectric layer supported by the substrate, excellent optical properties can be obtained while avoiding the processing difficulties related to polishing a hard substrate.

Examples include a regular array of nanoscale structures formed in a dielectric layer supported by a silicon carbide substrate (or other hard material). The nanoscale structures have at least one dimensional parameter less than 1 micron, for example less than 500 nm, where the dimensional parameter may be selected from structure spacing, structure thickness, and structure height. The dielectric layer may be amorphous silicon (a-Si). Such examples have great advantages over conventional silicon carbide optics, as they reduce the surface processing burden imposed by silicon carbide while retaining other advantages of this material, such as spectral transmission and strength.

The nanoscale structures may be protrusions having a sidewall profile, the side-wall profile being appreciably non-planar, the apparatus having spectral properties correlated with the sidewall profile.

In some example, the substrate supports a first dielectric layer, a metal layer, and a second dielectric layer as multilayer stack, the nanoscale structures being supported by (or formed in) the second dielectric layer.

Ridges may be formed in a substrate material, or on a coating layer formed on the substrate material. An example of the latter approach is high reflectivity can be obtained without polishing the substrate material to a mirror polish. This is a significant advantage for hard substrate materials, such as inorganic carbides (e.g. silicon carbides), nitrides, and the like, and for other substrate materials that for some reason are difficult to bring to a mirror finish.

An example apparatus, such as an optical element, comprises a substrate material and a coating layer supported by the substrate material. Protrusions, such as ridges or pillars, may be formed in the coating layer. The ridges may have a ridge height approximately equal to the thickness of the coating layer.

Example apparatus include an optical element having a substrate material comprising silicon carbide, with protrusions being formed in a coating layer. The coating layer may have a hardness appreciably less than the substrate material. The coating layer may comprise a dielectric material such as amorphous silicon (a-Si). The protrusions, such as ridges, have a portion proximate the substrate material, a central portion, and a distal portion. In some examples, the central portion of a protrusion has a width greater than the widths of proximate and distal portions.

An improved method of designing an optical element includes the optimization of the side wall structure, or other sub-wavelength feature, to obtain a desired spectral response. For example, the side wall structure may be represented by a mathematical function, such as a polynomial, and the function optimized using a genetic algorithm or other optimization algorithm to obtain the desired optical properties.

### BRIEF DESCRIPTION OF THE DRAWINGS

FIG. 1 illustrates a multi-spectral mirror design and performance;

FIG. 2 shows a design concept for a dual band stop IR filter, showing a complex side-wall profile formed in amorphous silicon (a-Si) on a silica substrate;

FIGS. 3A-3C illustrates design, field emission scanning electron microscopy (FESEM), and reflection properties of a fabricated sample;

FIG. 4 shows is a FESEM image showing further side-wall details of the fabricated sample;

FIG. 5 shows another design for a dual-band IR filter, using grooves with a complex side-wall profile formed in an a-Si layer;

FIGS. 6A-6B show simulated reflected properties of two designed reflectors;

FIGS. 7A-7B show simulated transmission properties of two designed reflectors;

FIG. 8 shows spectral properties of two simulated reflector samples measured using a spectrometer;

FIGS. 9A and 9B show a comparison of simulated and measured transmission for the reflectors;

FIG. 10 shows a comparison of simulated and measured reflection data for a reflector design;

FIGS. 11A-11E illustrate optimization of a side-wall profile for a high pass band and 2 stop band filter;

FIGS. 12A-12B show another example optimized anti-reflective (AR) surface;

FIGS. 13A-13B show the structure and properties of a three-layered structure, without grooves or other complex surface topography;

FIG. 14A-14C show a complex surface topography in the form of shaped pillars having a generally L-shaped profile; and

FIG. 15 shows the spectral properties of a device as shown in FIG. 14A.

### DETAILED DESCRIPTION OF THE INVENTION

Examples of the present invention include novel methods of fabricating optical devices, and optical devices having novel structures. Optical devices may include reflectors, transmission windows, and the like having multiple band responses (for example, high transmission or reflection at certain predetermined wavelengths).

Example apparatus include sub-wavelength structures in the surface of a structured material. The structured material may be a substrate material, or a coating layer formed on a substrate material. The sub-wavelength structures may include trench-like indentations in the surface, such as grooves. The grooves may be generally parallel. The side-walls may have a side-wall profile including features, such as generally concave and/or convex regions, configured to give desired optical response. The groove spacing and side-wall features may be sub-wavelength, i.e. less than the wavelength of electromagnetic radiation at operating wavelengths.

Some examples of the present invention include use of a coating layer on a substrate, with sub-wavelength structures being formed in the coating layer. In other examples, subwavelength structures are formed in the substrate, and no coating layer is required.

Devices with multiple bands, for example reflection bands or transmission bands, may be obtained using advantageous structures according to some examples of the present invention. Example devices also include improved optical windows, for example optical windows having a plurality of transmission bands. Examples also include devices having a combination of transmission and reflection bands.

Example devices provide an improved field of view, the field of view being wider than conventional devices, and may provide devices improved polarization independence.

Sub-wavelength structures can be formed in a single material structure (i.e. the etching is conducted in the substrate material itself, avoiding any CTE mismatch issue, adhesion or stress induced delamination of the coating). In other examples, one or more coating layers can be used, allowing for less complex patterns to achieve the desired optical property. The polarization and angular dependence of the optical elements can be controlled by the design of the sub-wavelength structures, allowing additional degrees of freedom not offered by traditional multi-layer coatings. The sub-wavelength structures may have metamaterial-like properties, with the size-scale of features being less than the electromagnetic wavelength. The optical properties may be simulated, for example using an effective medium theory.

Examples of the present invention, such as the use of subwavelength features in a coating layer, can be used with silicon carbide substrates, allowing improved SiC optics to be developed. However, examples of the present invention are not limited to SiC optics, and can be used with all types of optical substrates, including but not limited to: silica (SiO₂), other oxides; germanium and arsenic based IR glasses such as Ge—As—Se, As—Se, Ge—Sb—Se, As—Se, As—Se, As—S, and As—Se—Te, in particular IR glasses such as AMTIR-5; spinels; diamond; germanium (Ge); silicon (Si); beryllium (Be); selenides such as zinc selenide (ZnSe); sulfides such as zinc sulfide, including as the Cleartran form of ZnS, and other IR and/or visible wavelength substrates, including glass, polymer, semiconductor, dielectric, and other materials. In many of these examples, a separate coating layer (such as an a-Si layer) is not required.

The use of a mineralogical term such as diamond does not imply the use of naturally occurring materials, as such terms also refer to synthetic materials. Substrate materials may be any material suitable for formation of subwavelength structures, or to support a coating layer in which such structures are formed.

In some examples, a device may further include active materials such as liquid crystals, nonlinear materials, gain materials, phase change materials, and the like, allowing tunable properties. Examples include allowing tunable filters and other active optical elements. One or more transparent electrodes may be provided to allow electrically-tunable optical properties. For example, the surface of an apparatus may be coated with an electrode material, such as a transparent electrode, which may cover protrusions and an electrically tunable filler material located between the protrusions.

By fabricating sub-wavelength structures, such as etched patterns, the reflective (or transmissive) properties of an optical element can be controlled. The subwavelength structures may be formed in the substrate material itself, or within a single coating layer supported by the substrate. Examples of the present invention allow elimination of CTE mismatch issues, coating adherence and delamination issues, and multilayer film stress issues.

Design techniques can be generalized to one or two different materials, one as an optically thick substrate (e.g., quartz, silicon, SiC, and the like) and the other as a singly- or doubly-periodic structure with subwavelength features, including complex side-wall profiles formed in a coating layer (e.g., a-Si). subwavelength surface structures can be configured to obtain multispectral mirrors, filters, and antireflective coatings. A wide variety of design flexibility can be achieved including multiband or broadband properties as well as a specific polarization and/or angular response, through appropriate design of the subwavelength features. For example, one or more periodicities, groove depth, and/or side-wall profile can be designed to obtain the desired optical properties. In some examples, a substantially angular independent optical response can be obtained, for example at predetermined wavelengths.

Examples of the present invention include structures formed in a substrate, or within a single layer supported by a substrate. Unlike conventional devices, multi-spectral bands can be obtained without multilayer structures. For example, a mirror may have two or more bands of high reflectivity (for example greater than 95%) at predetermined wavelengths. A window may have two or more bands of high transmissivity (for example greater than 95%) at predetermined wavelengths. The high reflectivity peaks may be distinct, and separated by regions of lower reflectivity.

Example devices include subwavelength features, either in a substrate material or on a coating layer supported by the substrate. The optical properties may be determined substantially by the shape of a grating-like structure formed on the surface. However, the grating pitch may be appreciably less than the operating wavelengths, so that the optical properties are not determined by a simple diffraction theory. In fact, the optical properties may be determined using an effective medium model. For example, the side-wall profile of a subwavelength grating, which may have single or multiple periodicities, may be tailored to obtain a desired optical property. The side-wall profile may be optimized using a genetic algorithm technique.

Fabrication of a device, such as a mirror or window, can be generally easier and less expensive than conventional approaches because a multilayer structure is not required. There may be, for example, one or zero coating layers on a substrate. For example, a subwavelength grating may be formed in the substrate material itself, in which case no coating layers are required, or on a single coating layer.

In representative simulated and experimental examples, a silicon-based mirror design was designed and fabricated. Using a genetic algorithm, a plurality of strong reflection bands, having a reflectivity greater than 98%, was obtained at selected wavelengths. In specific examples the selected wavelengths were in the 8 to 12 micron band, in particular 8, 8.5, and 11 microns. Such structures can be formed in a coating layer supported by a substrate, or a subwavelength structure can be formed directly in the substrate. Experimentally, this was achieved using a silicon substrate with no separate coating layer.

In other examples, a coating layer may be formed on the surface of a mechanically hard substrate such as silicon carbide (SiC). Silicon carbide is difficult to process, but can be used as a substrate for a subwavelength grating formed within a coating layer supported by the substrate. Here, the term “grating” refers to generally parallel grooves formed within the surface structure. The periodicity of the grating may vary as a function of position over the substrate, and there may be more than one degree of periodicity.

The subwavelength structure, though described as a grating, may not operate as a conventional grating for the electromagnetic radiation. In particular, the size parameters associated with the grating may be substantially less than the wavelength of the electromagnetic radiation. The optical properties may be determined using techniques associated with metamaterials, such as an effective medium theory. The surface structure may also be determined using techniques associated with frequency selective surfaces (FSS).

Multi-band (such as dual or triple band) optical devices can be obtained. These may include mirrors, windows, reflectors, filters, and devices having some combination of these and other functionalities.

In some examples, improved polarization independent of the devices can be obtained. In some examples, improved broadband transmission can be obtained, in comparison with conventional devices.

The periodicity of grating structures may be less than the electromagnetic wavelength, for example less than λ/2, and more particularly in the region λ/5 to λ/10. The thickness of the coating layer may be in the region of microns, for example in the region 1 to 100 microns.

Mirror polishing is difficult with mechanically hard substrates, such as silicon carbide. Hence, it is advantageous to form mirror structures without needing to polish the silicon carbide substrate to a mirror finish. Examples of the present invention allow unpolished substrates to be used, as the optical properties are largely determined by the submicron features formed within a coating layer. Tailoring of the subwavelength features allows desired optical properties to be obtained, such as reflection, transmission, and the like, and further allows improved wavelength independence and/or polarization independence of the optical properties.

Conventionally, multi-wavelength devices required the use of multilayer dielectric stacks. However, there are potentially severe problems with such stacks, such as delamination. Traditional coatings require quarter-wave/multi-layer stack deposition, which is expensive, time consuming, and requires high vacuum machines. Moreover, there is a trade-off between the maximum transmittance/reflectance values and the number of layers, broadband properties, angular dependence, and field of view. These multilayer coatings are also polarization dependent. One of the main drawbacks with traditional coatings is the delamination/adhesion/stress problem due to CTE mismatch between the coating materials and the substrate, causing the coatings to fail if drastic temperature changes occur. Other sources of film stress and chemical incompatibility between the coatings and the substrate materials may also present problems. Further, the costs to obtain a multilayer are significantly in excess of those required for examples of the present invention.

Examples of the present invention include high power laser optics, in which the optical properties are provided by a single layer on a substrate or structures within the substrate itself. Conventional multilayer stacks conventionally suffer problems with differential thermal expansion under high incident radiation powers and may buckle, Further, the conventional use of metal films in such multilayer stacks causes disintegration under high powers. In examples of the present invention, the obtained optical properties are obtained using complex side-wall profiles. The exact side-wall profile can be modeled and designed using optimization algorithms to obtain the wavelength properties desired.

Optical devices may include, for example, devices operational at IR and/or visible wavelengths, and may include mirrors, windows, filters, lenses, prisms, and the like.

As a representative example, a multispectral IR mirror was designed, formed of only a single material (in this case, Si). A genetic algorithm (GA) was used to optimize the side-wall profile and unit cell size (periodicity) in order to meet a desired multispectral mirror response. The design goal was to achieve a reflection greater than 98% at three wavelengths (in this example, 8, 8.5, and 11 microns).

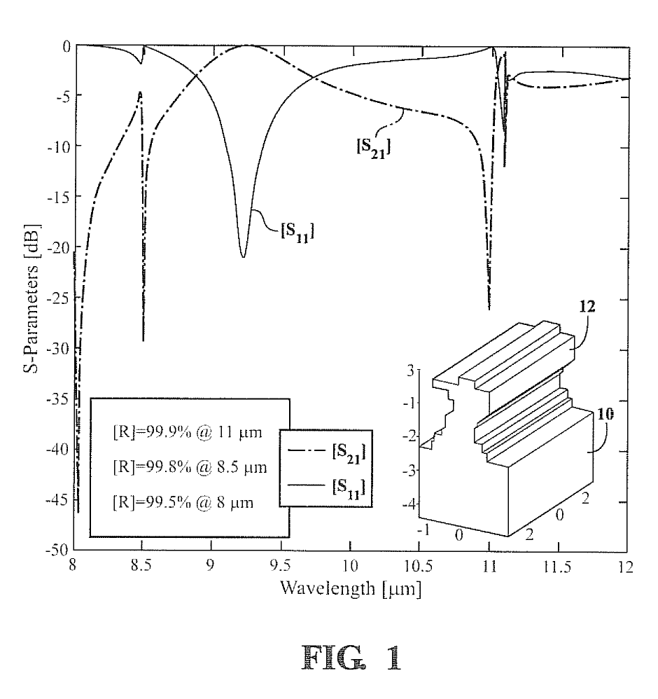

FIG. 1 shows the resulting design, a multispectral IR Si-only mirror design which exceeds the design requirements in each of the three bands. The figure shows the multi-spectral IR mirror performance, the strong reflection bands having a reflectivity of greater than 98%. The design was optimized using a genetic algorithm (GA) to achieve three strong reflection bands (>98%) at 8, 8.5 and 11 microns. The first curve |S₁₁| shows the reflection properties in the 8-12 micron band, while the second curve |S₂₁| shows the transmission. The inset shows the geometry for a unit cell 10 of the optimized 2D subwavelength grating, including ridges having shaped side-walls such as 12. These configurations are discussed in more detail below.

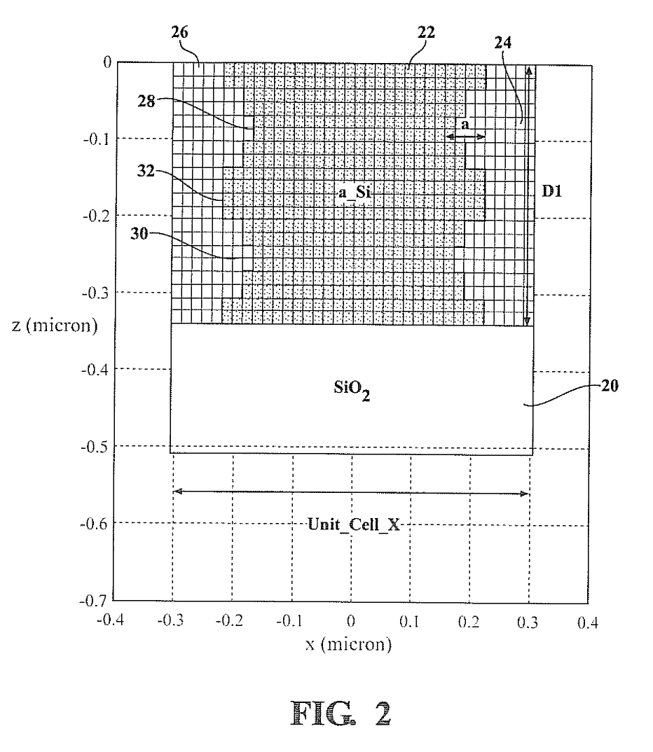

FIG. 2 shows a design for a dual band stop infrared filter. The illustrated unit cell structure is repeated over the surface to form a periodic pattern of ridges 22 and grooves (24, 26). The illustrated side-wall profile forms the boundaries of grooves having a width that varies as a function of height above the substrate in an oscillatory fashion. The groove has wider portions alternating with constrictions (in a direction normal to the substrate), the groove being widest between constrictions at the base, middle, and top of the groove.

The figure shows, in cross-section, a ridge 22 of amorphous silicon formed on a silicon dioxide substrate 20. The a-Si ridge has narrowed regions at 28 and 30, and these bound the corresponding wider regions of the grooves on each side. The groove has constrictions at the base, top opening, and the central portion due to the side wall at 32. In this example, the groove depth D1 is equal to the thickness of a coating layer of amorphous silicon (a-Si) on the substrate, in which the grooves are formed. A periodic grating is hence formed between a-Si ridge-like protrusions extending from the substrate. The unit cell spacing was approximately 0.6 microns. In this example high reflectivity was obtained at 1 micron and 1.5 microns, in this example high reflectivity being greater than 97%.

The depth of the grating-like structures may be equal to the thickness of a coating layer in which the grooves are formed, the grooves then extending through the coating layer down to the underlying substrate. In such examples, the sub-wavelength structures may be ridges of the coating material extending away from the substrate material. The grooves may extend in crossing directions across the substrate, for example as orthogonally crossing grooves, leaving pillars of a-Si having side-wall profiles on two or more sides.

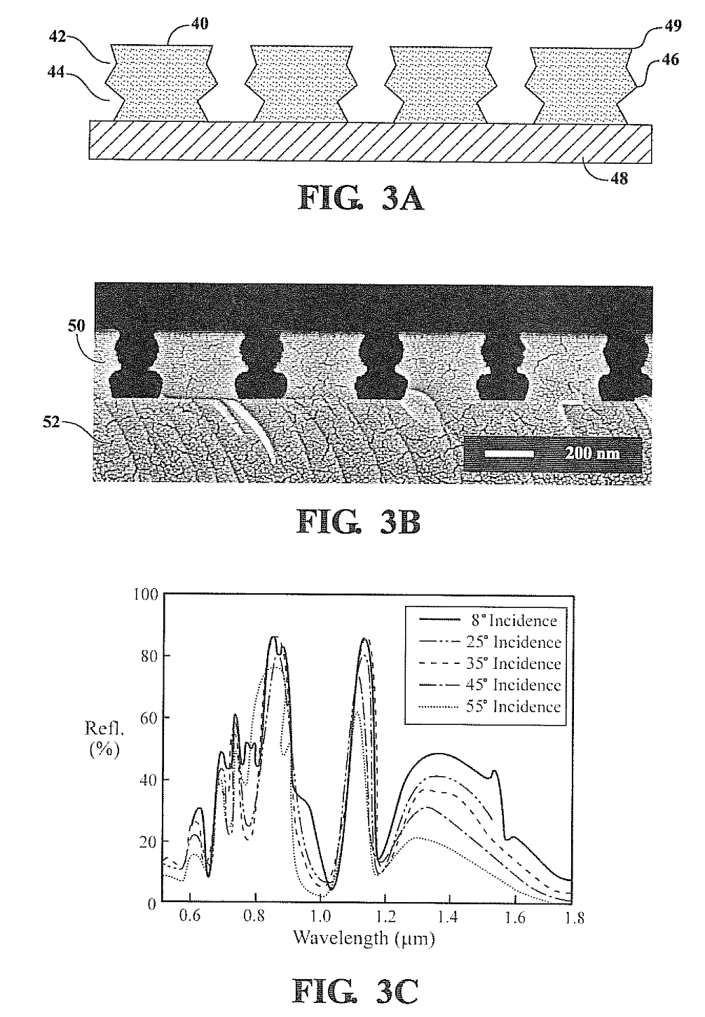

FIG. 3A-3C show design and properties of a fabricated device, showing the grating side-wall profiles formed in an amorphous silicon layer deposited on a quartz substrate. FIG. 3A shows the design used, including ridges 40 extending from substrate 48. The ridges have a side-wall structure including concave regions 42 (bounding the wider portions of the intervening grooves), and regions 46 that introduce constrictions in the grooves. This design is shown in more detail below, in FIG. 5.

FIG. 3B shows field emission scanning electron microscopy (FESEM) imaging of the fabricated structures, which closely match the design. The image shows ridges 50 in a-Si formed on a silica substrate 52.

FIG. 3C shows spectral properties of the fabricated samples, in the form of reflection properties at various incidence angles.

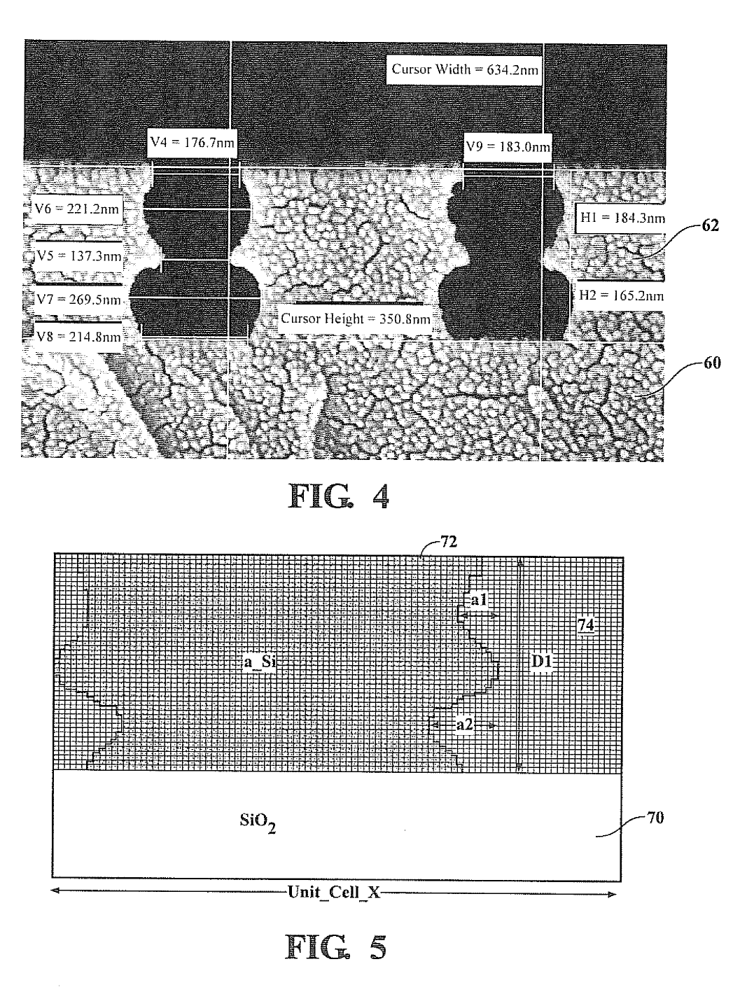

FIG. 4 shows another FESEM image view of the structure illustrated in FIG. 3B, showing the side-wall profile in slightly more detail. The figure includes distance measurements that are not discernable in this reproduction of the figure, but which are reproduced in the text below (rounded to the nearest nm). The distances given are approximate, and may vary between grooves. In this example, adjacent side-wall structures formed in adjacent a-Si ridges 62 encompass a groove having a base width of 215 nanometers (at the base of the groove, measured along the interface between the sculpted amorphous silicon (a-Si) layer and the underlying silica substrate). The groove has a non-uniform width measured in a direction normal to the substrate-coating a-Si layer interface. The groove has a constricted central region and a constricted opening. The spacing between side-walls reaches a first maximum of 270 nanometers, and then the groove narrows to a constricted central region having a width of approximately 137 nanometers (corresponding to the position 46 shown in FIG. 3A). There is a second wider portion having a width of approximately 221 nanometers and a second narrowing at the groove opening (corresponding to the position 49 shown in FIG. 3A) having a width of approximately 177 nanometers. The dimensions may vary from grating to grating, the properties of the overall device being responsive to averages.

Hence, an example structure may include grooves formed between side-walls, the side-walls having first and second concave regions separated by a generally convex region. The groove has wider portions bounded by the generally concave side-wall profiles, separate by a region of groove constriction formed by opposed convex regions of the side-wall profiles. The side-wall profile may be described as approximately a pair of adjacent arcs.

In some examples of the present invention, the opposed side-wall profiles defining a groove are approximately mirror images of each other. The ridges bounding the grooves may be narrower in regions proximate to and distal from the substrate, and wider in a middle region between the two narrower regions.

There may be a plurality of grooves that are generally parallel, extending over the surface. In some examples, there may be grooves extending in two or more directions, such as orthogonal sets of grooves. In the latter case, the protrusions from the surface may be pillar-like, having four sides having side-wall profiles as described herein.

FIG. 5 shows a further design for a dual band-stop IR filter, including parallel grooves (which may also be termed a grating) having a depth equal to the coating layer thickness, D1, which in this example is 0.35 microns. The widest parts of the grooves are enclosed by generally concave regions of the side-wall profile. Arrows A1 and A2 illustrate the deviation of the actual side-wall profile from a normal to the surface, and here are measured from the point of maximum groove constriction (where the side-wall protrudes furthest into the grating grooves). In this example A1 is 0.084 microns and A2 is 0.13 microns. The unit cell (X) is 0.6342 microns, defining the repeat dimension, or periodicity of the grating. In this example, the side-wall profile is formed in amorphous silicon, and the substrate is silica. This illustrated structure was a representation of the experimental device used for an effective medium model.

For the structure of FIG. 5, |R|=96.6% at 1.0 μm and |R|=98.9% at 1.41 μm, where measurements were taken at θ=8° as an approximation of normal reflectivity.

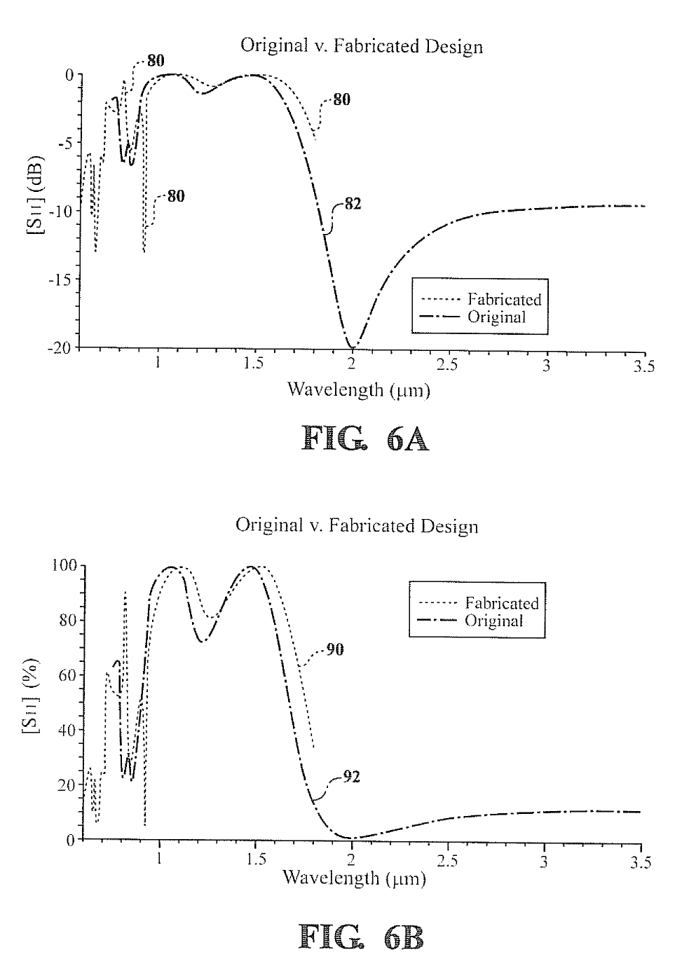

FIGS. 6A and 6B shows simulations for the design of FIG. 2 (referred to as the original or first design) and the design of FIG. 5 (which was the fabricated design as shown in FIGS. 3A-3C and FIG. 4). The S₁₁ curve is similar for both designs. FIG. 6B is a further comparison similar to that shown in FIG. 6A, in terms of percentage reflectivity. For the design of FIG. 2 (82, 92), reflectivity was 99.3% at 1.05 μm and −100% at 1.46 μm, and for the fabricated design (of FIG. 5) reflectivity (80, 90) was 99.2% at 1.1 μm, and 99.9% at 1.5 μm.

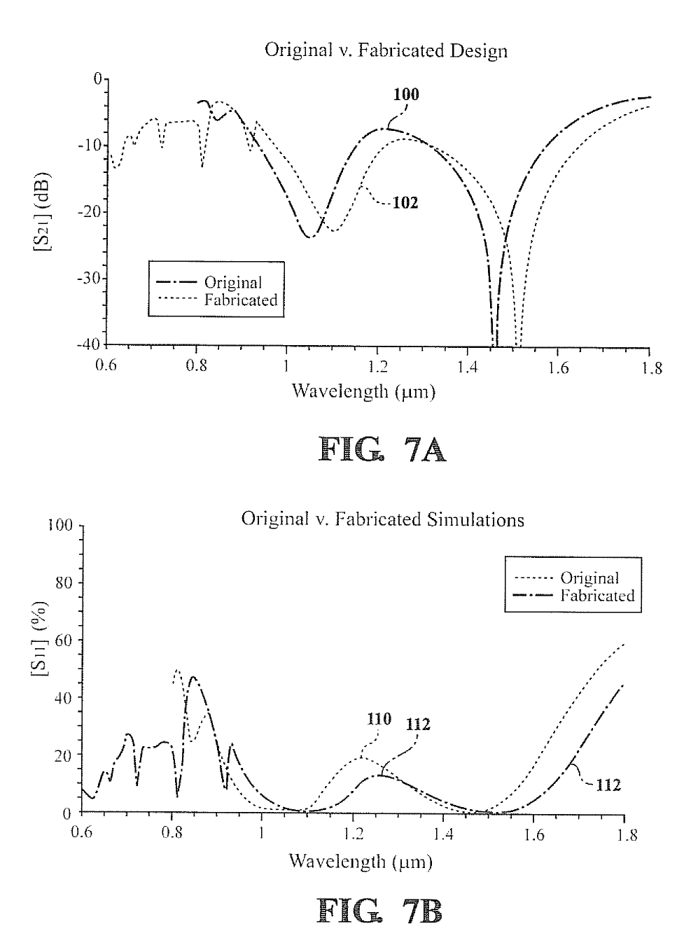

FIGS. 7A and 7B show further simulations for original design (FIGS. 2, 100 and 110) and fabricated design (102, 112) in transmission.

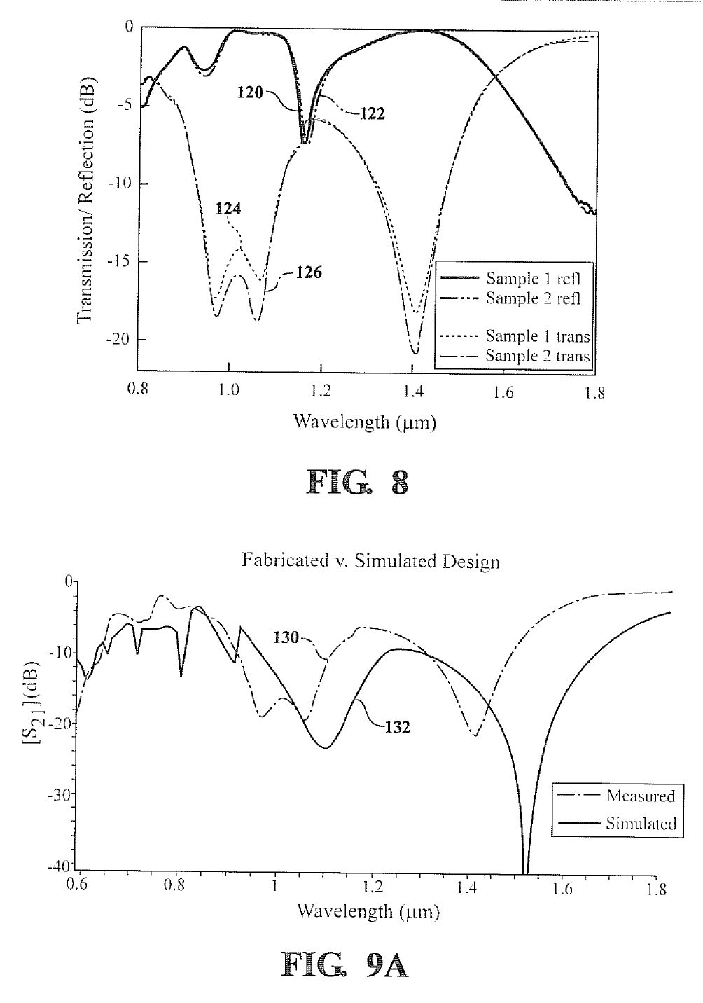

FIG. 8 shows measured spectra obtained using a UV visible spectrometer. The curves show reflectance and transmission in dB for first (120 and 124, respectively) and second (122 and 126, respectively) fabricated samples, as a function of wavelength from 0.8 to 1.8 microns. The agreement between the data show that reproducible results are possible using this approach.

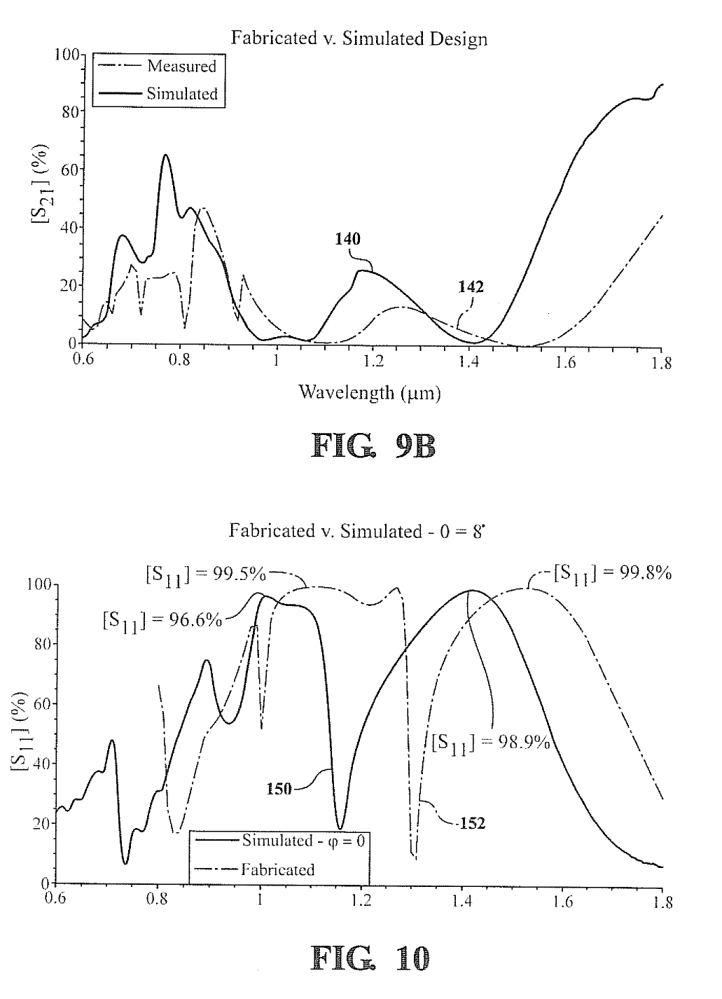

FIGS. 9A and 9B show comparisons between the measured performance of fabricated devices compared with the properties of simulated devices. FIG. 9A shows measured (130) and simulated (132) transmission data (dB), and FIG. 9B shows measured (140) and simulated (142) transmission data (percentage). Reasonable agreement is observed between 0.6 and 1.8 microns.

Agreement between simulated results and experimental results shows that the optical properties are obtainable by effective medium modeling, and that the grating response is not a conventional grating response based on interference.

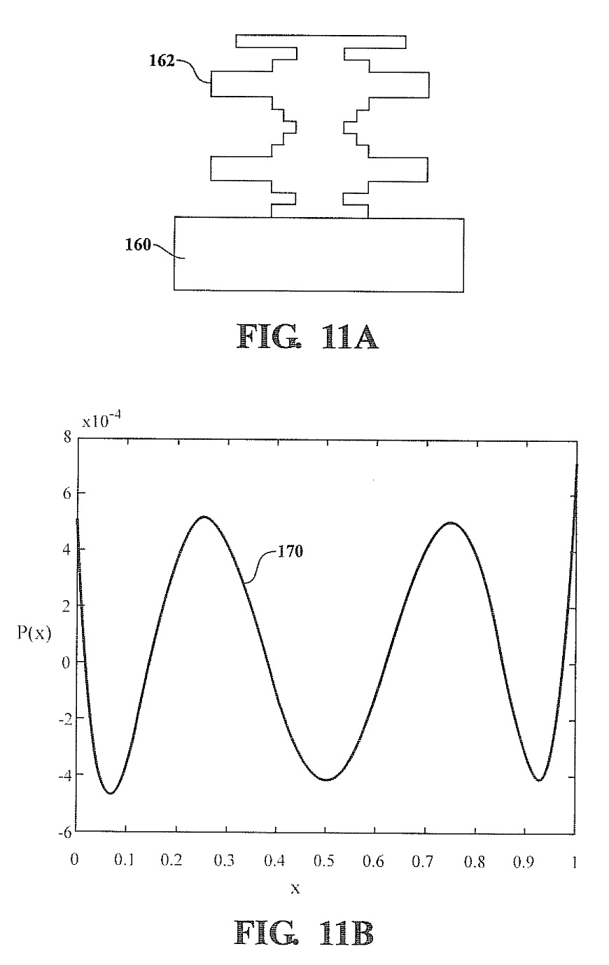

FIG. 10 shows a further comparison between measured (150) and simulated (152) results, in terms of percentage reflectance. The simulation was for normal reflection, whereas the experimental results were obtained at 8 degrees from normal due to limitations in the measuring instrument. The figure shows very high reflectivity peaks, as illustrated by the magnitude of the S₁₁ parameter. In all cases the S₁₁ parameter was greater than 96.6%.

Hence, examples of the present invention include multi-spectral mirrors having multiple-band reflection peaks, the reflection peaks being high reflectivity, e.g. having a reflectivity greater than 95%.

Side-Wall Profile Optimization

A new computationally efficient genetic algorithm (GA) optimization strategy was developed to design periodic 2D and 3D all-dielectric structures with complex side-wall profiles. In an example approach, the profile is represented as a polynomial with N roots, given by

P(x)=(x−x₁)(x−x₂) . . . (x−x_{N}), where x₁, x₂, . . . , x_{N} ∈ [0,1].

To create the side-wall profile, the polynomial is normalized and sampled according to the fabrication constraints imposed on the height and width of the ridges in the structure. The roots are encoded into a chromosome and optimized by a GA along with the period and height of the subwavelength features in the all-dielectric metamaterial structure for custom filter performances such as stop and pass bands, angular FOV, and polarization characteristics. To illustrate the flexibility of the design technique, a multi-spectral filter design was developed with a nanostructured surface that provides broadband transmission over a wide field of view (FOV).

The cost function for the design is given by

Cost=Γ_{2 μm}+(1−Γ_{1 μm})²+(1−Γ_{1.5 μm})²,

where a single passband was desired at 2 μm and dual stop bands were specified at 1 μm and 1.5 μm.

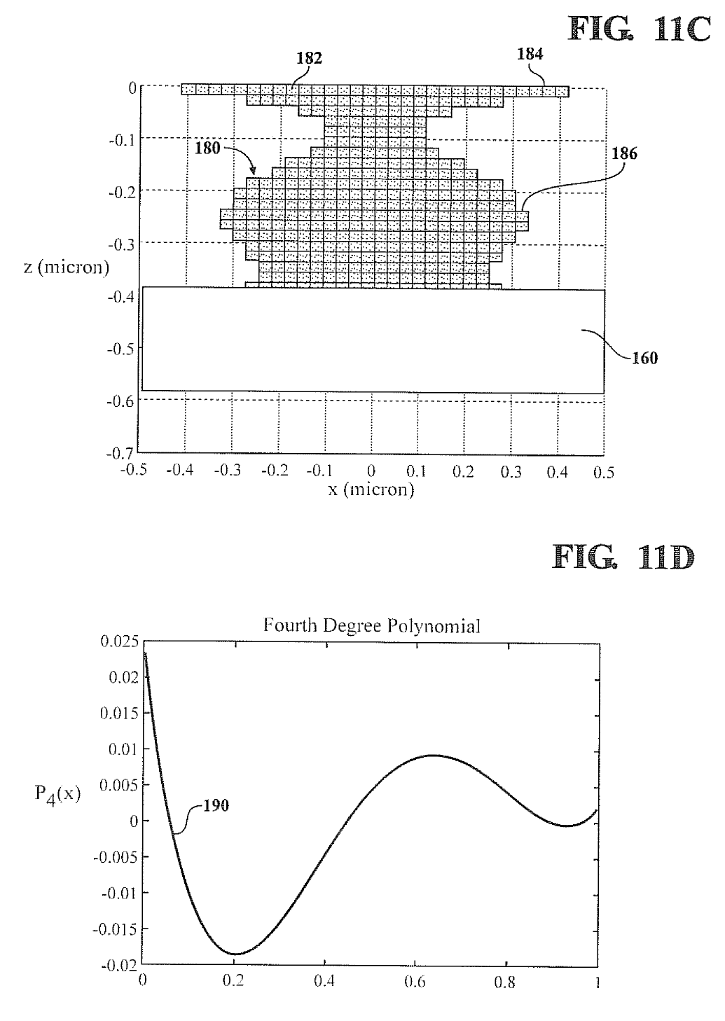

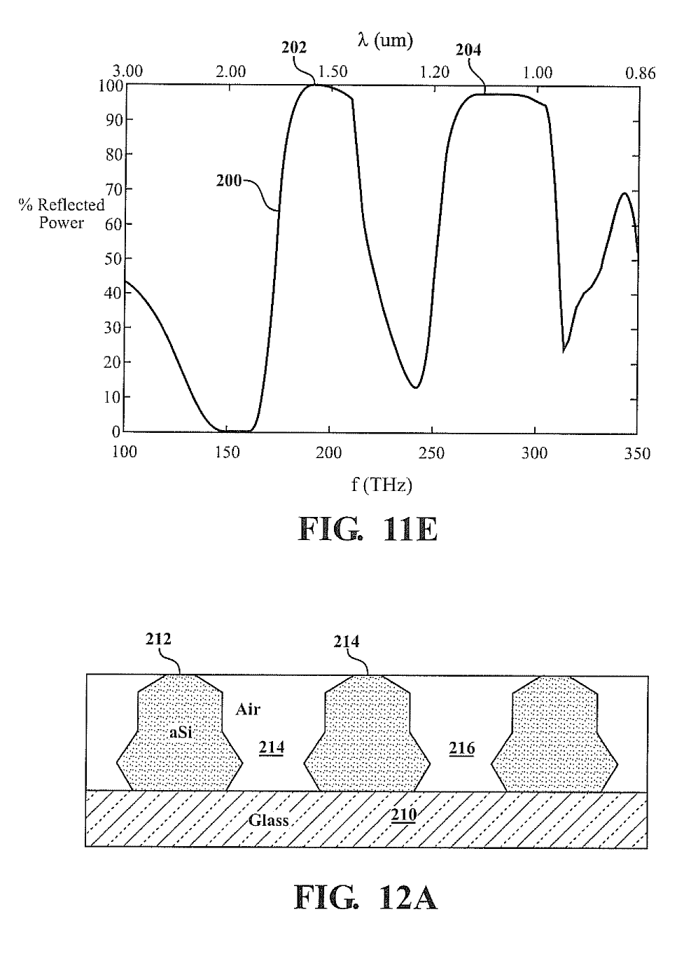

FIGS. 11A-11E illustrate GA optimization of side-wall profiles represented by polynomials for wavelength-selective 2D optical filters. FIG. 11A shows a ridge structure (162, formed on substrate 160) and FIG. 11B the corresponding polynomial (170) for a random element taken from the initial population created by the GA. The polynomial represents the lateral deviation of the side wall from vertical (as illustrated). The ridge structure is defined by the polynomial as an arbitrary member of the initial population.

After optimization, the final evolved structure (180) is shown in FIG. 11C, corresponding to fourth-order polynomial shown in FIG. 11D. The evolved ridge structure 180 formed in coating layer 182 includes lateral protrusions at 184 and 186, that correspond to constrictions of the neighboring grooves. The polynomial 190 is plotted from x=0 (the top of the groove at 184) to a value scaled to 1 at the substrate. The lateral deviations range from greater than 0.02 microns at x=0 to −0.02 microns (approximately) at x=0.2. The latter deviation corresponds to the widest part of the groove about one fifth of the way down the groove.

The simulated reflection spectrum 200 shown in FIG. 11E show a pass band (202) at 2 μm and stop bands (202 and 204) at 1 μm and 1.5 μm respectively, meeting the design criteria.

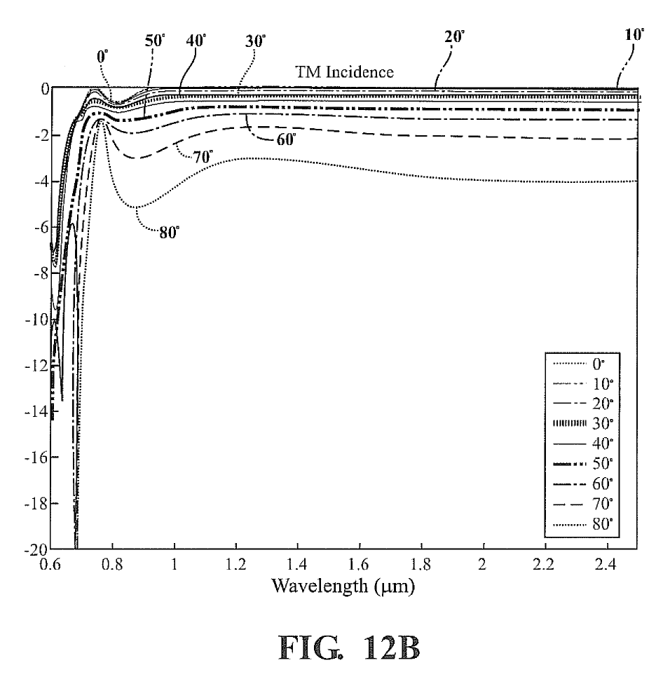

FIGS. 12A-12B shows the design and properties of an optimized anti-reflective (AR) coating that provides high transmission over an extremely wide bandwidth (2.4-0.8 microns) while at the same time exhibiting a wide FOV performance. FIG. 12A shows a few periods of the AR coating with a GA optimized side-wall profile, including protruding a-Si elements 212 and 214 formed on substrate 210, defining groove such as 214 and 216.

FIG. 12B shows the corresponding transmission spectra plotted in dB, showing broadband performance (as a function of wavelength) and wide FOV (as a function of incident angle) performance. The data for 0-50° merges together at the top of the graph, showing excellent performance over a wide range of incident angles and wavelengths.

Further Examples of Antireflective Coatings

An example layered AR structure was designed, comprising three layers formed on a substrate. An electrically conducting layer (such as a metal layer) was sandwiched between first and second dielectric layers. The first dielectric layer is adjacent the substrate, and for hard substrates such as SiC facilitates obtaining a smooth surface. This first dielectric layer may be omitted if the substrate is readily polished. A metal layer is supported by on the first dielectric layer, and a second dielectric layer is formed on the metal layer.

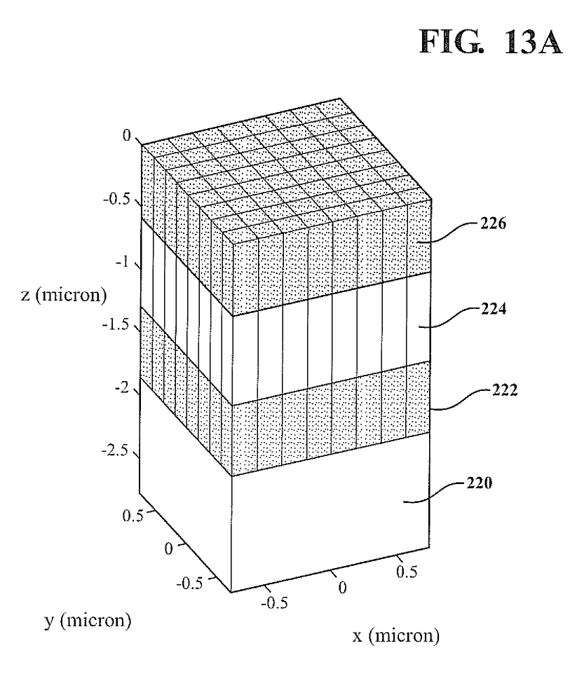

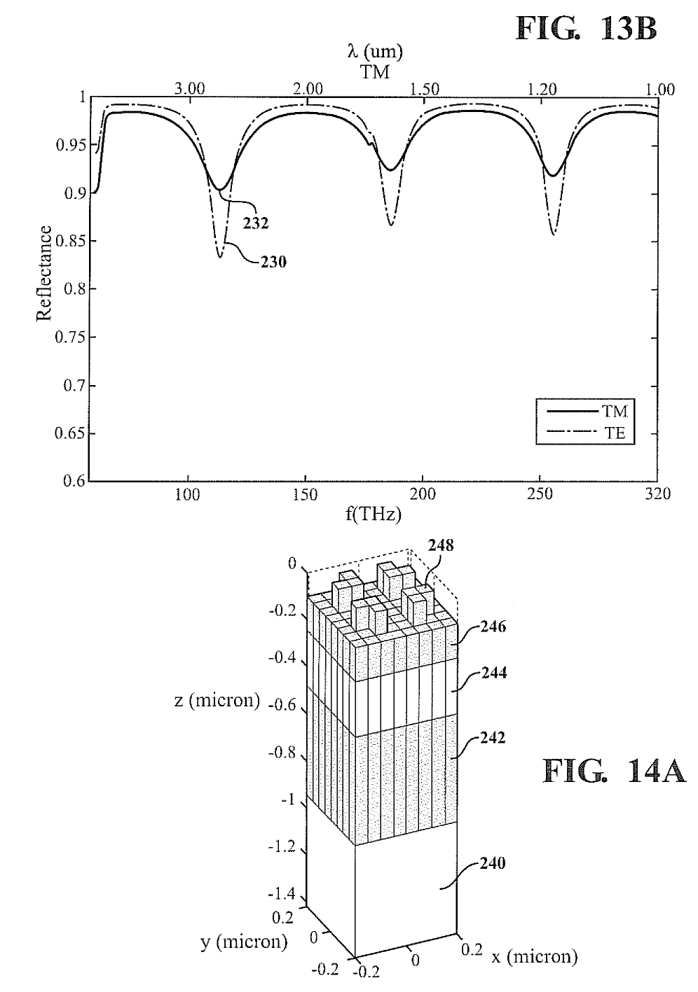

FIG. 13A shows a simulated example, with a substrate 220, a first layer of a-Si (222), a layer of gold in the middle (224), and second layer of a-Si (226) on top. The thickness of each layer can be optimized to meet a design specification. A representative example had the following dimensions, the top a-Si layer thickness was 577 nm, the gold layer thickness was 713 nm, the bottom a-Si layer thickness 562 nm, and the total trilayer thickness was 1.85 μm.

FIG. 13B shows the reflection properties of the structure of FIG. 13A, at 45 degrees angle of incidence. The reflectance function (232 for TM radiation, 230 for TE radiation) is periodic. Though overall reflectivity performance is good, there is less capability to tailor the design of the spectral response using a uniform layered structure.

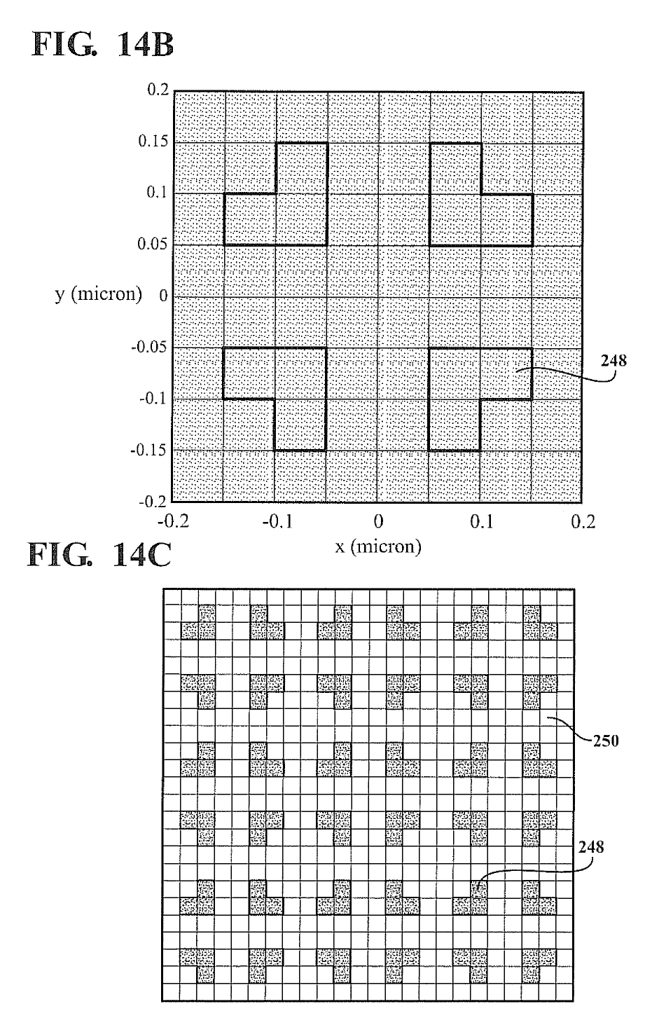

FIGS. 14A-14C illustrate a structure similar to that shown in FIG. 13A, further including a nanostructured topography (248) on the upper dielectric layer (246). The nanostructured topography may be considered an additional a-Si layer with voids (air holes) within it, on top of a uniform dielectric layer. The thickness of each layer and the location of air holes can then optimized to meet the design specification.

FIG. 14A shows a representative unit cell structure, which may be repeated over a substrate surface. The structure has substrate 240, first dielectric layer 242, metal layer 244, second dielectric layer 246, and structured layer 248.

FIG. 14B represents a top view of the structured surface, showing the location of generally L-shaped protrusions (248) from the surface of the second dielectric layer. The protrusions may be the same or different composition from the second dielectric layer, in this example the composition is the same.

FIG. 14C is a top view of a repeated pattern of protrusions 248, surrounded by voids 250. Looking down on the structure, the top of second dielectric layer 246 would be visible through the void regions 250. A surface may include many such unit cells, possible several orders of magnitude than those shown in FIG. 14C.

The protrusion have a generally L-shaped cross-section in the surface plane. Other protrusion configurations may be used, such as other shapes include a generally L-shaped portion within the cross-section (such as T-shaped or “+” shaped cross-sections). Protrusions may include a regular array of ridges, including ridges elongated various directions, such as perpendicular directions.

The grid pattern visible in FIGS. 13A, and 14A-14C relate to the simulation process, and do not correspond to real physical structure. These patterns, on a lateral grid scale of 0.05 microns, also facilitate visualization of the structures.

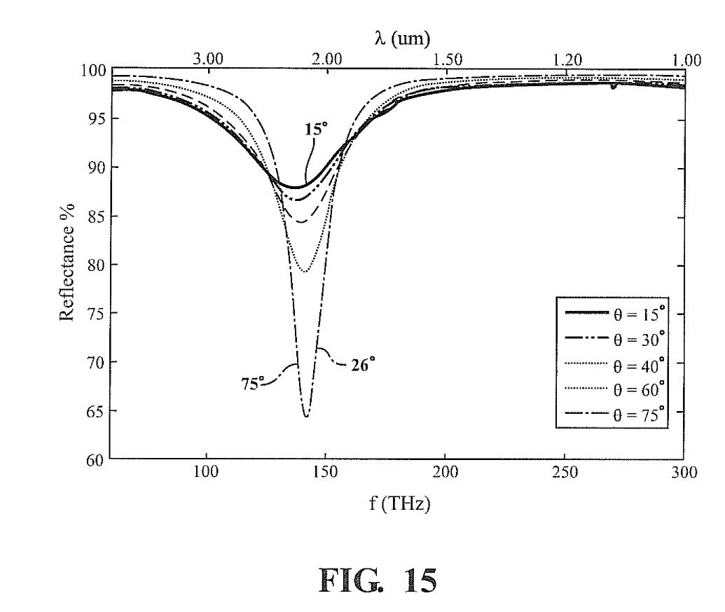

FIG. 15 shows the spectral response of the structure of FIG. 14A-C. The figure shows reflectance percentage as a function of incidence angle. For example, curve 260 shows data for an incidence angle of 75° from normal.

The structure can be optimized to a desired spectral response through selection of optimized layer thicknesses, protrusion height, and protrusion configurations. Hence, the presence of nanostructured protrusions from the surface allows a desired spectral response to be obtained.

Substrate Materials

Substrates may be formed comprising any suitable material, such as dielectric materials, semiconductors, glasses, polymers, semiconductors, metals, dielectrics, and the like. Representative examples include materials such as silicon carbide and diamond, for which polishing may be problematic.

Other example substrate materials may comprise silica (including silica glass), spinel, diamond, germanium, silicon, beryllium, zinc selenide, and zinc sulfide (e.g., Cleartran®), other chalcogenides, and the like. Substrate materials may include glasses, ceramics, polymers, and the like.

The subwavelength structures may be formed directly in the substrate material, if this is feasible and/or economical.

An advantage of methods and apparatus according to examples of the present invention is that the substrate need not be polished, and in particular need not be polished to a mirror finish. This is a particular advantage for a hard material such as silicon carbide, which typically is difficult to polish without deposition of further silicon carbide layers. The subwavelength features can be formed in a coating layer deposited on the substrate, or directly in the substrate. The coating layer also need not be polished, in particular need not be polished to a mirror finish.

Coating Layer

A coating layer may be formed on the substrate, particularly if it is not straightforward to obtain the subwavelength structures directly into the substrate material. The coating layer may comprise any suitable material, such as a dielectric or semiconductor material, polymer, glass, or other material. Examples include silicon (in particular amorphous silicon), germanium (in particular amorphous germanium), beryllium, other semi-metals, selenides (such as zinc selenide), sulfides (such as zinc sulfide), other chalcogenides (including as oxides), and the like.

Subwavelength Structures

In examples of the present invention, the optical properties of the device are largely determined by the structural form of the subwavelength structures. In contrast to conventional devices, multilayer structures showing appreciable interference effects are not required. The subwavelength structures may comprise spaced apart ridges defining grooves. The ridges (and hence grooves) may have a complex side-wall structure, for example the ridges having a narrowed portion near where they are adjacent the underlying material, a broader ridge region, and a narrowed region away from the underlying material. The broader ridge regions may constrict the groove within a constricted groove region separating two regions of wider groove region.

Subwavelength features may include ridges, other protrusions such as rods which may have similar side-wall profiles as described herein, grooves, depressions such as indentations, and the like. Protrusions, such as ridges, or depressions such as grooves or holes, may be arranged in one or two dimensional arrays, including geometric arrays. In some examples, the spatial arrangement may be random. In some examples, size parameters (such as spacing) may have a spatial gradient along one or two directions in the plane of the surface.

A genetic algorithm can be used to optimize the side-wall profile and/or unit cell size (periodicity) to obtain a desired multi-spectral response. The substrates may be optically thick, for example a multiple of the electromagnetic wavelength. Applications include multi-spectral mirrors, filters, and antireflective coatings. The polarization and angular dependence of the optical properties can be optimized using an algorithm, for example to control the periodicity and side-wall profile. Conventionally, these cannot be controlled in a multilayer stack configuration.

In some examples, sub-wavelength structure properties may be spatially dependent, for example to obtain gradients in properties. For example, the surface region including the subwavelength structures may have an effective index dependent on the structure properties.

Complex wall profiles can be implemented to design metamaterial-like coating layers. A metamaterial-like coating layer can be considered to be a coating layer that gains its resulting properties from its structure rather than its composition. The desired transmission/reflection properties can be achieved by etching patterns, such as grating-like structures, on the surface of the substrate material itself or a coating layer thereon.

Fabrication Examples

Structured surfaces may be obtained by any suitable method. Example fabrication methods include replication methods such as direct transfer.

In some examples, complex side-wall profiles may be obtained using a compositional variation through the layer in which the grooves or other structure are formed. For example, the etch rate of the coating layer may vary as a function of distance from the substrate surface, along a direction perpendicular to the substrate. Hence, side-wall etching then proceeds at different rates according to the local composition of the layer, which varies as a function of position in a manner correlated with the compositional variation. In a representative example, the coating layer may comprises SiₓGe₁₋ₓ, where x varies as a function of position measured through the layer.

Silicon Carbide Optics Examples

In representative examples, a silicon (e.g. amorphous Si) layer is formed on a SiC substrate, and all processing steps are conducted on the a-Si coating layer. The a-Si coating layer several advantages. No mirror finishing polishing of the substrate, such as SiC optical substrates, is required. Minimal effort is required to polish the a-Si layer prior to the etching step, compared with that required to polish the SiC layer. The coating layer, such as an a-Si layer, can be much easier to etch than the substrate (such as SiC), and complex wall profiles can be implemented.

Silicon carbide has a number of properties making it attractive for use in optical elements, such as low density, high strength, low thermal expansion, high hardness, and excellent thermal shock resistance. However, it is extremely difficult to polish SiC substrates, because of the high strength and chemical inertness properties of SiC. Hence, conventional SiC optics demands costly and time consuming finishing processes that require the use of diamond-based polishing tools and diamond slurries.

In a typical process used to fabricate SiC optical components (e.g. POCO Graphite process), the lack of material homogeneity and the presence of surface defects does not allow for a well-polished mirror surface finish. A Chemical Vapor Deposited (CVD) SiC layer may be applied in order to create a polishable optical surface. However, the SiC surface still requires expensive (e.g. diamond turning) and time consuming polishing processes before the deposition of the mirror stack.

SiC based mirrors conventionally require deposition of reflective coatings to achieve the required reflectivity at targeted wavelengths. Multi-layer designs are typically required to achieve good optical performance, but the coating performance is restricted in terms of incidence angles and polarization. Mismatch between the coefficient of thermal expansion of the SiC substrate and the currently used optical coating materials causes thermal stresses and delamination of the coatings, resulting in a coating failure. SiC etching is extremely difficult and time consuming, etch rates are low, and complex profiles are difficult to achieve.

Examples of the present invention include devices having a silicon layer, such as an amorphous silicon layer, formed on a silicon carbide substrate. Such structures are not common, and the formation of subwavelength features within the silicon overcoating layer has not previously been achieved. The silicon can be deposited by any one of various techniques, such as chemical vapor deposition (CVD).

Examples of the present invention include an amorphous silicon layer formed on a silicon carbide substrate. Further, the etching of subwavelength structures within the silicon carbide layer allows improved optical properties to be obtained, such as tailored reflectance, absorption, or other properties. Subwavelength features may be fabricated using one or more of various processes, such as etching, replication, and the like.

Applications

Applications include optical elements such as reflectors (mirrors), transmission elements (windows), refractive components such as lenses, absorbers, filters, and devices having a combination of such features. Applications include dual band and other multiple band elements, and radio wave shielding applications, such as antenna shielding.

Specific examples include notch filters having two or more stop bands within a desired spectral region, for example the near-IR. Using the novel designs described herein, there need not be a harmonic or other periodic-like frequency relationship between adjacent stopped bands.

Examples of the present invention include instruments containing optical elements as described herein, such as spectrometers, microscopes, imaging devices such as cameras, telescopes, binoculars, and the like.

Examples also include acoustic analogs of the optical devices. For example, an improved acoustic tile may include protrusions or other components as described herein, adapted for acoustic wavelengths. A protrusion with appropriately shaped side-wall (for example, configured for maximum absorption of sounds of interest) may be configured in foam, concrete, or any other appropriate material, and used in applications such as acoustic shielding, improved ultrasound imagers, road noise reduction, concert halls, and the like.

A substrate may be planar or curved. For example, sub-wavelength structures may be formed on the curved surface of a lens, for example to obtain an antireflective coating.

Examples include a multi-band optical element having an optical property optimized at a plurality of wavelengths by configuration of the side-wall structure and the periodicity.

Examples include IR and/or visible and/or UV optical elements. For example, an example is an IR-visible optical element having an operational wavelength range of 0.4 to 12 microns spectral range. Other example include a near-IR elements having an operational wavelength range of 0.8 to 12 microns. Example ranges are not intended to be limiting.

Other examples include an IR optical element having a high reflectivity or high transmissivity at first and second predetermined wavelength, the electromagnetic wavelength being in the range 0.8-100 microns, more particularly 1-50 microns. The first and second predetermined wavelengths may be separated by a wavelength spacing of at least 0.2 microns, more particularly 0.5 microns, and in some examples at least 1 micron. A high reflectivity may be a reflectivity of at least 90%, more particularly 95%, and in some examples at least 97% (e.g. as a ratio of reflected to incident intensities), and a high transmissitivity may be a transmissivity of at least 90%, more particularly at least 95%.

In some examples, the optical element does not include any metal. For example, the substrate and/or coating layer may be non-metallic, for example a dielectric material or semiconductor.

Particular examples include IR optics, such as IR windows, in which the wavelength may be micron-scale (e.g. in the range 1-100 microns), and surfaced structure features such as pitch (periodicity) may be nanoscale (e.g. in the range 1-1000 nm) and less than the wavelength, in some examples less than one half the wavelength.

Tunable Devices

Tunable devices may be formed by combining the subwavelength structure with tunable materials, either to form the subwavelength structures or to fill voids or grooves. For example, an electrically tuned liquid crystal can be used. Other examples of tunable materials may include photo-reflective, other electro-optic, and magneto-optical materials. Example devices allow particular values of optical properties, such as reflection, transmission, or absorption, to be obtained at predetermined wavelengths. The optical properties and predetermined wavelengths may be substantially dependent on the form and dimensions of the subwavelength properties.

The invention is not restricted to the illustrative examples described above. Examples described are not intended to limit the scope of the invention. Changes therein, other combinations of elements, and other uses will occur to those skilled in the art.

Having described our invention, we claim:

1. An apparatus, the apparatus being an optical element having an operational electromagnetic wavelength range, the apparatus comprising:
a substrate;
an array of protrusions extending from the substrate along an extension direction, the protrusions having a side-wall profile,
the side-wall profile undulating relative to the extension direction,
the protrusions having a spacing less than radiation wavelengths within the electromagnetic wavelength range.

2. The apparatus of claim 1, the optical element being a window, mirror, filter, lens, or prism.

3. The apparatus of claim 1, the apparatus being an IR optical element, the protrusions having a spacing of less than 1 micron.

4. The apparatus of claim 3, the apparatus having at least two high reflectivity peaks within the operational electromagnetic wavelength range, each high reflectivity peak having a reflectivity of at least 95%.

5. The apparatus of claim 3, the side-wall profile including an oscillatory component having an amplitude of at least 50 nm.

6. The apparatus of claim 1, the protrusions including ridges supported by the substrate,
the ridges defining grooves therebetween,
the grooves having a groove width that varies along the extension direction, the grooves having at least one narrowed region between first and second wider regions.

7. The apparatus of claim 6, the ridges having a first side-wall, a second side-wall, and a top surface,
the first and second side-walls having side wall profiles that are mirror-images of each other.

8. The apparatus of claim 1, the protrusions being pillars,
the pillars having at least one pair of side-walls, each having a side-wall profile that undulates relative to the extension direction.

9. The apparatus of claim 1, the substrate being silicon carbide.

10. An apparatus, the apparatus being an optical element having a radiation-receiving surface configured to receive electromagnetic radiation, the apparatus comprising:
a substrate; and
a sub-wavelength grating supported by the substrate, the sub-wavelength grating defining grooves along the radiation-receiving surface, the grooves having a groove base proximate the substrate, and a groove opening,
the sub-wavelength grating having a side-wall profile such that each groove has at least one narrowed portion located between the groove base and the groove opening.

11. The apparatus of claim 10, the subwavelength grating being formed by an array of protrusions extending from the substrate,
the protrusions having a protrusion spacing less than radiation wavelengths within an operational wavelength range of the apparatus.

12. The apparatus of claim 10, the optical element being a window, mirror, filter, lens, or prism.

13. The apparatus of claim 10, the apparatus being an IR optical element, the protrusions having a spacing of less than 1 micron.

14. The apparatus of claim 10, the substrate being silicon carbide, the sub-wavelength grating being formed in a dielectric coating layer supported by the substrate.

15. An optical element, comprising:
a silicon carbide substrate;
a regular array of nanoscale structures formed in a dielectric layer supported by the silicon carbide substrate,
the nanoscale structures having at least one dimensional parameter less than 1 micron,
the dimensional parameter being selected from a group consisting of structure spacing, structure thickness, and structure height.

16. The apparatus of claim 15, the dielectric layer being amorphous silicon.

17. The apparatus of claim 15, the nanoscale structures being protrusions having a sidewall profile, the side-wall profile being appreciably non-planar,
the apparatus having spectral properties correlated with the sidewall profile.

18. The apparatus of claim 15, the silicon carbide substrate supporting a first dielectric layer, a metal layer, and a second dielectric layer as a three-layer stack,
the nanoscale structures being supported by the second dielectric layer.
